(19) United States
(12) Patent Application Publication
(10) Pub. No.: US 2026/0037651 A1
(43) Pub. Date: Feb. 5, 2026

(54) METHODS FOR DIGITAL ACCESS MANAGEMENT ON A COMPUTING DEVICE

(71) Applicant: The Toronto-Dominion Bank, Toronto (CA)

(72) Inventors: Lauren TANG, Toronto (CA); Ronald Allan KIELSTRA, Beamsville (CA); Anil Stewart BAKHLE, Guelph (CA); Andy Jason LY, Guelph (CA); Lan Ting HUANG, Toronto (CA); Amanda VANZANTE, Oakville (CA)

(73) Assignee: The Toronto-Dominion Bank, Toronto, ON (CA)

(21) Appl. No.: 18/793,065

(22) Filed: Aug. 2, 2024

(51) Int. Cl. G06F 21/62; H04M 15/00

(52) U.S. Cl. CPC G06F 21/62; H04M 15/58

(57) ABSTRACT

A computer-implemented method is disclosed. The method includes: obtaining, via a computing device, device usage data associated with a first service that is accessible on the computing device; querying at least one network node of a first network to obtain network resource usage data associated with the computing device; generating recommendation data comprising a plurality of data records corresponding to usage instances for the first service based on the device usage data and the network resource usage data; and causing to be modified at least one device setting of the computing device based on the generated recommendation data. The recommendation data may be generated by a recommendation engine that is implemented as an artificial intelligence (AI)-powered assistant.

### TECHNICAL FIELD

The present application relates to digital access management and, more particularly, to a system and methods for managing access of subscription services on computing devices.

### BACKGROUND

Various digital products and services are provided on a subscription basis. A merchant/service provider may offer pre-defined subscription packages having different sets of products, features, and accessibility. Customers may either select from a list of pre-defined packages or build a customized package that suits their preferences, expected usage or consumption level, and personal valuation of the product/service.

As the subscription model becomes increasingly more popular, customers may find it challenging to effectively manage their subscribed-to products and services. Existing subscription management tools automate certain processes relating to subscription notifications or cancellations, but generally lack complexity in providing customers with actionable analytics and recommendations across multiple different providers or platforms.

### BRIEF DESCRIPTION OF THE DRAWINGS

Embodiments are described in detail below, with reference to the following drawings:

FIG. 1 is a schematic diagram illustrating an operating environment of an example embodiment;

FIG. 2A is high-level schematic diagram of a computing device;

FIG. 2B shows a simplified organization of software components stored in a memory of the computing device of FIG. 2A;

FIG. 3 shows, in flowchart form, an example method for controlling access to a service that is provided on a computing device;

FIG. 4 shows, in flowchart form, an example method for controlling access to a subscription service that is provided on a computing device;

FIG. 5 shows, in flowchart form, an example method for providing customized recommendations based on subscription usage data across a plurality of user devices;

FIG. 6 shows, in flowchart form, an example method for determining a recommended mix of subscriptions based on service feature overlap analysis; and

FIG. 7 shows, in flowchart form, an example method for tracking device usage across a plurality of user devices for determining user preference data and a recommended mix of subscriptions.

Like reference numerals are used in the drawings to denote like elements and features.

### DETAILED DESCRIPTION OF VARIOUS EMBODIMENTS

In an aspect, a computing system is disclosed. The computing system includes a processor and a memory coupled to the processor. The memory stores computer-executable instructions that, when executed, configure the processor to: obtain, via a computing device, device usage data associated with a first service based on tracking at least one of: sensor data of sensors associated with the computing device, the sensor data corresponding to defined device actions associated with the first service; or device interaction events associated with the first service comprising input for interacting with the computing device; query at least one network node of a first network to obtain network resource usage data associated with the computing device; generate recommendation data comprising a plurality of data records corresponding to usage instances for the first service based on the device usage data and the network resource usage data; and cause to be modified at least one device setting of the computing device based on the generated recommendation data.

In some implementations, the first service may be a subscription service that offers products or services in accordance with a subscription model.

In some implementations, the memory may store a first application associated with the first subscription service and obtaining the device usage data may include tracking sensor data of the sensors during periods of usage of the first application.

In some implementations, generating the recommendation data may include identifying duplicated data among the plurality of data records for merging into a single data record.

In some implementations, the duplicated data may be identified based on comparing values in data fields comprising at least one of usage period, subscription name, or usage duration associated with the data records.

In some implementations, obtaining the device usage data may include querying the computing device for device screen time associated with periods of usage of the first application.

In some implementations, the instructions, when executed, may further configure the processor to obtain output of custom software for collecting at least one of connection usage time or browser application usage time.

In some implementations, the instructions, when executed, may further configure the processor to cause a message containing the generated recommendation data to be presented via the computing device.

In some implementations, causing the at least one device setting to be modified may include enabling a restriction on usage of the first application.

In some implementations, the instructions, when executed, may further configure the processor to obtain tracking data of a health tracking service for a user of computing device, and the recommendation data may include recommended subscriptions usage information based on the tracking data and usage patterns associated with the first subscription service.

In some implementations, the at least one network node may comprise a computer server associated with a connection service provider (CSP).

In another aspect, a computer-implemented method is disclosed. The method includes: obtaining, via a computing device, device usage data associated with a first service based on tracking at least one of: sensor data of sensors associated with the computing device, the sensor data corresponding to defined device actions associated with the first service; or device interaction events associated with the first service comprising user input for interacting with the computing device; querying at least one network node of a first network to obtain network resource usage data associated with the computing device; generating recommendation data comprising a plurality of data records corresponding to subscription usage instances for the first service based on the device usage data and the network resource usage data; and causing to be modified at least one device setting of the computing device based on the generated recommendation data.

In yet another aspect, a non-transitory computer readable storage medium is disclosed. The computer readable storage medium contains instructions thereon which, when executed by a processor, configure the processor to: obtain, via a computing device, device usage data associated with a first service based on tracking at least one of: sensor data of sensors associated with the computing device, the sensor data corresponding to defined device actions associated with the first service; or device interaction events associated with the first service comprising user input for interacting with the computing device; query at least one network node of a first network to obtain network resource usage data associated with the computing device; generate recommendation data comprising a plurality of data records corresponding to subscription usage instances for the first service based on the device usage data and the network resource usage data; and cause to be modified at least one device setting of the computing device based on the generated recommendation data.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Example embodiments of the present application are not limited to any particular operating system, system architecture, mobile device architecture, server architecture, or computer programming language.

The present application discloses a cross-platform system for managing subscriptions. The system enables detailed tracking of subscription usage data and utility metrics in connection with a customer's subscribed-to services. The subscription usage data and utility metrics may be provided to customers in a format that facilitates actionable response by the customers to modify or cancel one or more subscriptions. Additionally, or alternatively, a software tool may leverage the subscription usage data and utility metrics to automatically process changes to one or more on-device applications and/or instruct remote subscription servers to modify individual subscriptions.

A customer's banking app on their device may be used to coordinate the collection of subscription usage data, or account activity, from a plurality of different data sources. The customer's historical transaction data may be used to identify one or more subscription services, and an on-device search of applications associated with the identified services may be performed. In some implementations, the banking app may be embedded with features for the customer to actively manage their subscriptions.

When a subscription service is provided via an app that is also installed on the customer's device, device usage data may be collected and usage of the subscribed-to service can be inferred at least based on the device usage data. In some implementations, the banking app may provide deep linking to the related subscription service app(s) that are resident on the customer's device. Device usage pertaining to the subscription service may be determined based on at least one of the application data of the subscription service app or system data (e.g., screentime reports, network resource use report, etc.) of the customer's device identifying app-specific usage periods and/or duration for installed apps. The device usage data may be aggregated across multiple different devices of the customer.

Using the customer's bank account information (e.g., historical transaction data), the system may identify one or more connection service providers (CSP) such as, for example, cell service provider, home internet provider, etc. The servers associated with these connection service providers may be queried for historical data usage information describing the customer's cell and internet data consumption. The historical data usage information can, in turn, be used as a basis for inferring subscription usage data.

Custom software (e.g., plug-in extension, etc.) may be provided to the customer for installing on their router and/or web browser application to collect subscription usage data. The subscription usage data collected by the software may be communicated to the system on-demand or periodically.

The system may automatically perform cross-referencing of the device usage data, CSP data, and custom software data in order to generate refined subscription usage data. More particularly, the system provides an intelligent analytics engine that is configured to: identify duplicate subscription usage data records from disparate sources and perform merging of records as suitable; identify content consumed for each of one or more subscription services and provide content-specific interpretation of the subscription usage data; and perform data filtering to distinguish between content browsing and actual content consumption time (e.g., by tracking async requests).

From the aggregated and refined subscription usage data, the customer's total usage-per-period-per-service may be determined. The customer may also be provided with utility calculation that represents a measure of the utility of a given subscription service in dollars per unit-time. For example, the cost-per-period can be divided by the usage-per-period to obtain cost-per-usage, expressed according to the customer's preferred format.

The customer may consent to data from multiple subscription services across multiple devices being merged. By way of example, health tracking service data may be combined with subscription usage data of an entertainment content provider to identify correlations between sleep quality and subscription usage patterns. The correlations can form the basis of recommendations of subscription/device usage for the customer.

The present application also discloses a cross-platform engine for subscription recommendations. The recommendation engine is configured to provide the customer with an optimal mix of subscriptions based on, at least, budgeting rules, service-related preferences, and subjective-ranking preferences. The recommendation engine may be implemented as an artificial intelligence (AI)-powered assistant which automates tasks associated with subscription management. The tasks may include, among others: negotiating service agreements with service providers; changing or cancelling subscription plan(s); canceling new subscriptions before the end of a “free trial” period; searching for competing offers from alternative service providers; identifying changes to subscription prices or unexpected “add-on” purchases; comparing the catalogs or offering of the individual subscriptions.

The recommendation engine is designed to recommend an optimal package, or combination, of subscription(s). A customer may desire to increase the utility of spending in a specific subscription category (e.g., video streaming). The recommendation engine may be configured to review the products (or features) that are available from a plurality of service providers in the category, facilitate identifying customer preferences in absolute and/or relative terms, and recommend a subscriptions package that maximizes derived utility for the customer. This can also be accomplished by reducing the number of overlapping services being offered by the subscription services.

The customer may be prompted by the recommendation engine to indicate products which they consider to be irreplaceable as well as a ranking of favorite/preferred products. The recommendation engine uses a tiered ranking of the available products. Initially, the irreplaceable products are each assigned a defined utility score, and all other products are assigned a lower default score. For each service provider, the recommendation engine calculates the total utility available to the customer, based on the assigned scores. The recommendation engine can then generate a recommendation of a subscription mix that provides the customer with the highest level of utility.

In some implementations, if the recommendation engine has access to other customers' data, the “default” utility scores of products can be tuned to account for similarities between customers (e.g., demographics, preferences, etc.). The recommended mix may be compared against a set of constraints defined by the customer relating to, for example, total spend per period, total number of subscriptions, compatibility with region, operating system, etc.

The recommendation engine accesses the customer's bank account data (e.g., historical transactions data) as well as other personal information in refining the recommended mix of subscriptions. For example, the recommendation engine may use credit card bill information, customer location information, and the like, for generating a refined list of recommendations for the customer. Other supplementary data, such as application data of installed apps, device usage data, etc. may also be used by the recommendation engine for providing the recommended subscriptions mix.

The recommendations generated by the recommendation engine may be formatted as a “negative filter” on existing set of subscriptions which facilitates identifying subscription(s) for cancellation. For example, the utility scoring system implemented by the recommendations engine may be used to build a negative filter identifying products/features that the customer does not desire (or least desires). The negative filter can be dynamically updated based on inferences or manual input of customer preferences.

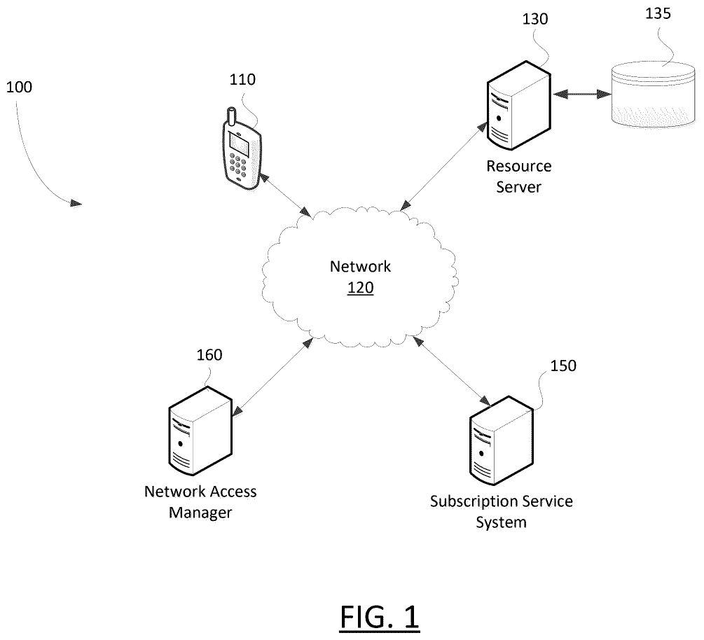

Reference is first made to FIG. 1, which illustrates an example networked environment 100 consistent with certain disclosed embodiments. As shown in FIG. 1, the networked environment 100 may include client devices 110, a resource server 130, a database 135 associated with the resource server 130, subscription service systems 150, network access manager 160, and a communications network 120 connecting various components of the networked environment 100.

The resource server 130 and the client devices 110 communicate via the network 120. In at least some implementations, the client device 110 is a computing device. The client device 110 may take a variety of forms including, for example, a mobile communication device such as a smartphone, a tablet computer, a wearable computer (e.g., head-mounted display, smartwatch, etc.), a laptop or desktop computer, or a computing device of another type. The client device 110 is associated with a client entity, such as an individual or organization, having resources which are managed by or using the resource server 130. For example, the resource server 130 may be a financial institution server and the client entity may be a customer of a financial institution that operates the server. The client device 110 may store software instructions that cause the client device 110 to establish communications with the resource server 130.

The resource server 130 may be configured to track, manage, and maintain resources, and/or lend resources to a client entity associated with the client device 110. In some implementations, the resources may comprise computing resources, such as memory or processor cycles. In some other implementations, the resources may include stored value, such as fiat currency, which may be represented in a database. As shown in FIG. 1, the resource server 130 is coupled to a database 135, which may be provided in secure storage. The secure storage may be provided internally within the resource server 130 or externally. For example, the secure storage may be provided remotely from the resource server 130, and include one or more data centers storing data with bank-grade security.

The database 135 may include records for a plurality of accounts and at least some of the records may define a quantity of resources associated with the client entity. For example, the client entity may be associated with an account having one or more records in the database 135. The records may reflect a quantity of stored resources that are associated with the client entity. Such resources may include owned resources and, in some implementations, borrowed resources (e.g., resources available on credit). The quantity of resources that are available to or associated with the client entity may be reflected by a balance defined in an associated record such as, for example, a bank balance.

In at least some implementations, the database 135 stores various types of information relating to customers of a business entity that administers the resource server 130. For example, the database 135 may store customer profile data and financial account data associated with customers of a financial institution. The customer profile data may include, without limitation, personal information of registered customers, authentication credentials of the customers, account identifying information (e.g., checking and/or savings account numbers), and information identifying the services (e.g., banking services, investment management services, etc.) and programs that are offered to the customers by the business entity.

The resource server 130 may provide an interface for accessing the stored data of the database 135. In particular, the resource server 130 may implement a backend of software that can be used by client entities to interact with their accounts and associated data records. The software may, for example, be a resource account management application, such as a mobile banking application for managing personal or business bank accounts. Various functions of the resource account management application may be provided, at least in part, by the resource server 130. The resource account management application may enable users to perform account operations, such as accessing personal finance information, defining financial goals, configuring allocations of resources, etc., using their client device 110.

FIG. 1 includes a subscription service system 150. As used in the present disclosure, the term “subscription” refers to a business model in which a customer pays a recurring price at regular defined intervals for access to certain services. A subscription service system 150 administers subscriptions for subscribing customers. The terms “subscription” and “subscription plan” are used herein interchangeably to refer to data describing billing strategies for subscriptions. A subscription plan may indicate, for example, product(s) being subscribed to, subscription price, and billing interval.

In at least some implementations, the subscription service system 150 is configured to deliver a subscription service to subscriber entities. A “subscription service” refers to a service that is accessible only upon activating a subscription. The features of a subscription service can be accessed only by (paying) customers that are subscribed to the service. The subscription service system 150 may comprise servers that implement a platform through which a subscription service is rendered. Examples of services that may be delivered by the subscription service system 150 include media (e.g., video, music, etc.) streaming services, cloud gaming services, health and fitness tracking services, software-as-a-service (Saas), remote learning course services, and the like.

The subscription service system 150 may store subscription information for customers of the service. In at least some embodiments, the subscription service system 150 is configured to perform various operations relating to management of subscriptions including, but not limited to: administering user registrations; modifying or cancelling subscription plans; updating subscriber information for subscriptions; processing requests to obtain subscription profile data; and payments (e.g., subscription fee payments) processing in connection with subscriptions.

A network access manager 160 is also illustrated in FIG. 1. The network access manager 160 may be configured to track, evaluate, and control the client devices' 110 access to the network 120. In some implementations, the network access manager 160 comprises server(s) of a connection service provider, such as an Internet service provider (ISP), that provides Internet access to users of the client devices 110. Alternatively, the network access manager 160 may comprise a mobile network operator (i.e., a wireless carrier) providing wireless communications services.

The client devices 110, the resource server 130, the subscription service systems 150, and the network access manager 160 may be in geographically disparate locations. Put differently, the client device 110 may be remote from the resource server 130, the subscription service systems 150, and/or the network access manager 160. As described above, each of the client device 110, the resource server 130, the subscription service systems 150, and the network access manager 160 may be a computer system.

The network 120 is a computer network. In some embodiments, the network 120 may be an internetwork such as may be formed of one or more interconnected computer networks. For example, the network 120 may be or may include an Ethernet network, an asynchronous transfer mode (ATM) network, a wireless network, or the like. Additionally, or alternatively, the network 120 may be or may include one or more payment networks. The network 120 may, in some embodiments, include a plurality of distinct networks. For example, communications between certain of the computer systems may be over a private network whereas communications between other of the computer systems may be over a public network, such as the Internet.

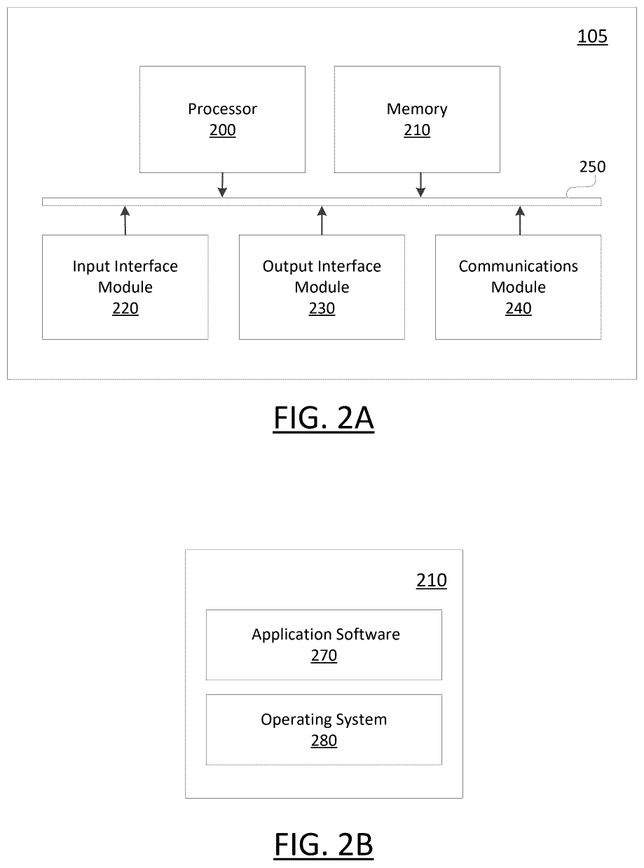

FIG. 2A is a high-level operation diagram of an example computing device 105. In some embodiments, the example computing device 105 may be exemplary of one or more of the client devices 110, the resource server 130, and the subscription service system 150. The example computing device 105 includes a variety of modules. For example, as illustrated, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. Processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some embodiments, all or a portion of the input interface module 220 may be integrated with an input device. For example, the input interface module 220 may be integrated with one of the aforementioned example input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some embodiments, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards. For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like.

Additionally, or alternatively, the communications module 240 may allow the example computing device 105 to communicate using near-field communication (NFC), via Wi-Fi™, using Bluetooth™ or via some combination of one or more networks or protocols. Contactless payments may be made using NFC. In some embodiments, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated, these software components include an operating system 280 and application software 270.

The operating system 280 is software. The operating system 280 allows the application software 270 to access the processor 200, the memory 210, the input interface module 220, the output interface module 230 and the communications module 240. The operating system 280 may be, for example, Apple iOS™, Google's Android™, Linux™, Microsoft Windows™, or the like.

The application software 270 adapts the example computing device 105, in combination with the operating system 280, to operate as a device performing particular functions. In some implementations, the application software 270 may comprise a resource account management application. The resource account management application may enable users to access and control various aspects of their resource accounts using the computing device 105. For example, the resource account management application may be a mobile banking application for managing personal or business bank accounts. The resource account management application may provide functions for, among others, accessing past activity data (e.g., historical transactions data) of one or more resource accounts and their associated data records. In particular, a customer of a financial institution can use the resource account management application on their device to access activity records corresponding to past transaction (e.g., credit, debit) activities.

In some implementations, the application software 270 may comprise a subscription service application. Certain subscription services may be accessed using applications installed on computing devices. For example, mobile applications may provide access to services (e.g., media streaming, fitness tracking, etc.) to which a device user is subscribed. The mobile applications may be standalone software on a computing device, and subscribed-to services may be accessed by enabling the device user's active subscriptions on the mobile applications.

While FIG. 2B illustrates a single application software 270, in operation, the memory 210 may include thereon a plurality of application software 270. Each application software 270 may be configured to perform its own set of functions on the computing device 105.

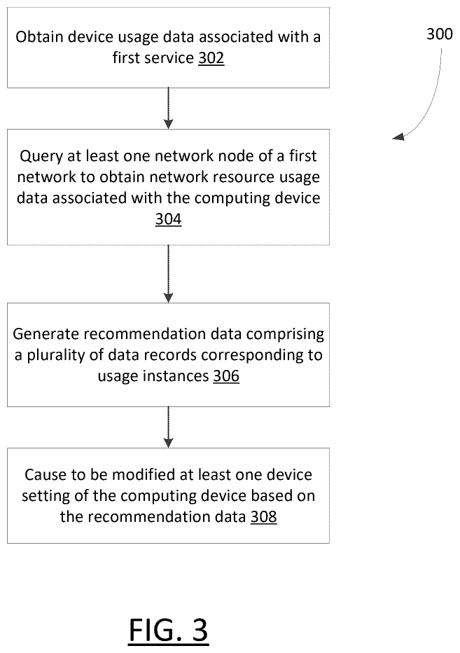

Reference is now made to FIG. 3 which shows, in flowchart form, an example method 300 for controlling access to a service that is provided on a computing device. The method 300 may be implemented by a computing system that is communicably connected to one or more devices associated with a user of the service. By way of example, the computing system may comprise a server computer that is connected, via a communications network, to one or more devices used by a subscriber entity to access a subscription service. Certain services, such as media streaming services, can be accessed on multiple different user devices (e.g., mobile phones, smart TVs, etc.). A computing system that is connected to a plurality of user devices may implement the method 300 in managing access to a given subscription service on each of the user devices. In some implementations, the computing system may itself be one of the devices that is used for accessing the subscription service. Operations 302 and onward may be performed by one or more processors of the computing system such as, for example, the processor 200 (FIG. 2A) of a suitably configured instance of the example computing device 105 in FIG. 2A.

In operation 302, the computing system obtains, via a computing device, device usage data associated with a first service that is provided on the computing device. In at least some implementations, the first service is a subscription service. The computing device is a device that is associated with a user, such as a subscriber entity, of the first service. In particular, a subscribed user accesses a first subscription service using the computing device. For example, the computing device may store, in memory, at least one application associated with the first service. The application may be used for accessing, receiving, or otherwise interacting with features of the first service. The computing device may be one of multiple devices associated with the user that are enabled for accessing the first service.

The computing system obtains the device usage data associated with the first service based on tracking usage information of one or more users of the device. In particular, the computing system may determine the device usage data via use of tracking (or other) software that is configured to detect usage information associated with the first service. In some implementations, the computing system may obtain one or both of: sensor data of sensors associated with the computing device; or event data of device interaction events associated with the first service. The sensor data corresponds to defined device actions associated with the first service. In particular, the sensor data includes data that is collected from one or more sensors when the defined device actions are detected on the computing device. The sensor data may be collected from various different types of on-device sensors such as: cameras, capacitive sensors, accelerometer, gyroscope, barometer, magnetometer, optical heart rate sensor, electrical heart sensor (ECG), light sensor, fingerprint sensor, light sensor, proximity sensor, microphone, etc. The tracked sensor data may allow for inferring active use of the device to estimate durations of device usage in connection with the first service.

By way of example, a defined device action associated with the first service may be the launching of a software application (e.g., a native app) that is resident on the computing device and that enables user access of the first service. When the software application is launched, the computing device may begin collecting sensor data from one or more on-device sensors. The software application may be associated with a set of sensors that are designated for collecting application data. For example, the designated set of sensors for a software application may be predetermined, and may depend on the user interactions that are available for the software application.

The sensor data may be collected until the software application is closed or exited, either manually by the user or automatically by the operating system of the device (e.g., for memory management). The computing system may query the computing device on-demand for the sensor data collected during periods of use of the software application. For example, if the computing system receives a request to determine device usage data associated with the first service for a defined period of time, the computing system may query the computing device to obtain sensor data that was/is collected during the defined period.

In some implementations, the computing system may be configured to additionally query for device screen time associated with periods of use of the software application. While screen time may be a useful indicator of device usage, it may not always accurately describe usage of the software application (and by association, the first service). For example, if a software application (e.g., a music streaming or fitness tracking app) is allowed to run in the background during active use such that it is not persistently displayed on the device screen, the screen time may not fully capture usage of the software application. The device screen time may thus serve as supplementary information that is used in conjunction with collected sensor data in estimating device usage in connection with the first service.

As another example, one or more cameras and optical sensors associated with the computing device may combine to produce eye-tracking data. The cameras and sensors may be used for measuring either the point of gaze or the motion of eyes relative to a user's head. The eye-tracking data may indicate areas of the user's visual attention. In the context of subscription use, sensor data may be collected from the cameras/sensors during periods of inferred user access of a service. The collected sensor data may form the basis of estimates of device usage in connection with the service. In particular, the inferred areas of the user's visual attention may be compared with locations of the computing device and/or points of interest on the device screen in order to determine periods of active use of the computing device.

The device interaction events associated with the first service comprise user input for interacting with the computing device. In at least some implementations, a device interaction event may include an input provided, via an input interface, by a user of the computing device. For example, the user may provide input (e.g., touch gesture, mouse click, etc.) for interacting with a software application, such as a mobile app, associated with the first service. The input may be registered via a user interface (e.g., GUI) of the software application. Additionally, or alternatively, the input may be in the form of motion and/or gesture for directly controlling, manipulating, or otherwise using the computing device. For example, the computing device may be a wearable device, and a device interaction event may comprise motion and gesture input that is provided by the user during active use of the first service (e.g., fitness tracking service).

In some implementations, a device interaction event may include a user response to a prompt for information regarding their use of the first service. For example, when a software application associated with the first service is launched on the computing device, the user of the device may be prompted, periodically or at predetermined times, to provide input for confirming that they are using the first service at the time of the prompt. In response to such a prompt, the user may indicate, on the computing device, active use of the first service. If the user provides a confirmatory input, said input may be treated as a device interaction event for the first service.

The tracked data for a device interaction event may indicate, among others, interaction type, start and end times of interaction, total duration of interaction, type and/or content of prompt (if any) for usage information, etc. The device interaction event data may be stored in memory, for example, in association with an application that is associated with the first service.

In at least some implementations, the computing system may additionally obtain, via the computing device, historical activity data of a software application associated with the first service. The historical activity data may represent activities of a user during their use of the software application on the computing device. The historical activity data may be stored in memory, for example, as part of app data and/or metadata of the software application. By way of example, historical activity data of a media streaming app may include indications of media items (e.g., movies, shows, songs, etc.) consumed by the user on the computing device. The historical activity data may include, for example, identifying information for the consumed media item, length of media content, date and time of consumption, and the like.

In operation 304, the computing system queries at least one network node of a communications network to obtain network resource usage data associated with the computing device. More particularly, the computing system obtains, via one or more network nodes, data regarding historical usage of network resources by the computing device. In at least some implementations, the at least one network node may include a computer server associated with a connection service provider (CSP). A CSP may be, for example, a cell service provider, home Internet provider, and the like. The computing system may be configured to query server(s) of CSPs to obtain data usage history of the user of the computing device. The data usage history relates to one or more users of the computing device and may indicate, among other information, amount of cellular and Wi-Fi data used, and date and time of data usage.

In some implementations, the computing system may also obtain output of custom software for collecting at least one of connection usage time or browser application usage time. The custom software may, for example, be router software installed on a router that enables the computing device to access an Internet connection. The router software may be configured to identify and provide reports of usage of the first service and/or associated apps via the Internet connection. As another example, the custom software may be a browser extension, or similar software module, for customizing a web browser. The browser extension may be configured to identify and provide reports of usage, via the web browser, of the first service.

The computing system generates recommendation data comprising a plurality of data records (“usage records”) corresponding to usage instances for the first service, in operation 306. The recommendation data is generated based on, at least, the device usage data and the network resource usage data. A usage record represents a period of continuous use of the first service. In particular, each usage record may be a record that indicates continuous use of the first service on any one of a subscriber's devices. The data fields of a usage record may include, among other information: date and time of use; total usage time; platform or source of usage data (e.g., mobile app, subscriber's router, etc.); and description of the service use (e.g., media item consumed, etc.). In some implementations, a usage record may be generated only if the time of continuous use, i.e., total usage time, exceeds a defined minimum threshold amount of time.

In generating the recommendation data, the computing system leverages the aggregated data of the usage records to determine values of certain metrics relating to usage and utility of the first service. For example, the computing system may determine the device user's total usage-per-period. The period may be initially defined by the terms of a subscription agreement associated with a first subscription service (e.g., per month, year, etc.), and then normalized to the user's preferred unit of comparison. Similarly, the usage may be defined in [days]:[hours]:[minutes], and then normalized to the user's preferred unit of comparison. Additionally, or alternatively, the computing system may be configured to calculate a measure of the utility of the first subscription service. That is, the utility derived from access/use of the first subscription service may be expressed in monetary terms. To calculate the utility, the cost-per-period may be divided by the usage-per-period to obtain cost-per-usage, expressed in the user's preferred units (e.g., dollars per unit-time).

In operation 308, the computing system causes to be modified at least one device setting of the computing device based on the generated recommendation data. That is, the computing system performs certain operation(s) for effecting changes to the computing device on the strength of the recommendation data. The changes may relate, for example, to controlling access to the first service on the computing device. In some implementations, the computing system may cause to be enabled, on the computing device, a restriction on usage of an application associated with the first service. In particular, one or more application settings of the application for accessing the first service may be automatically initialized or modified. For example, the computing system may impose a defined maximum/upper limit on usage-per-period of the application on the computing device. The application may, for example, be disabled, or use of the application may be caused to be at least temporarily halted, after passage of a defined duration of use, in accordance with the modified application setting(s). In this way, access of the first service on the computing device over any defined unit of time may be controlled to align with recommendations generated by the computing system.

In some implementations, the computing system may cause a message containing the generated recommendation data to be presented via the computing device. The message may be provided on the computing device, for example, as a reply to a query for usage data and/or usage value information. The message may contain usage and utility metrics as well as detailed records of use (i.e., usage records) pertaining to the first service, aggregated across a plurality of different devices.

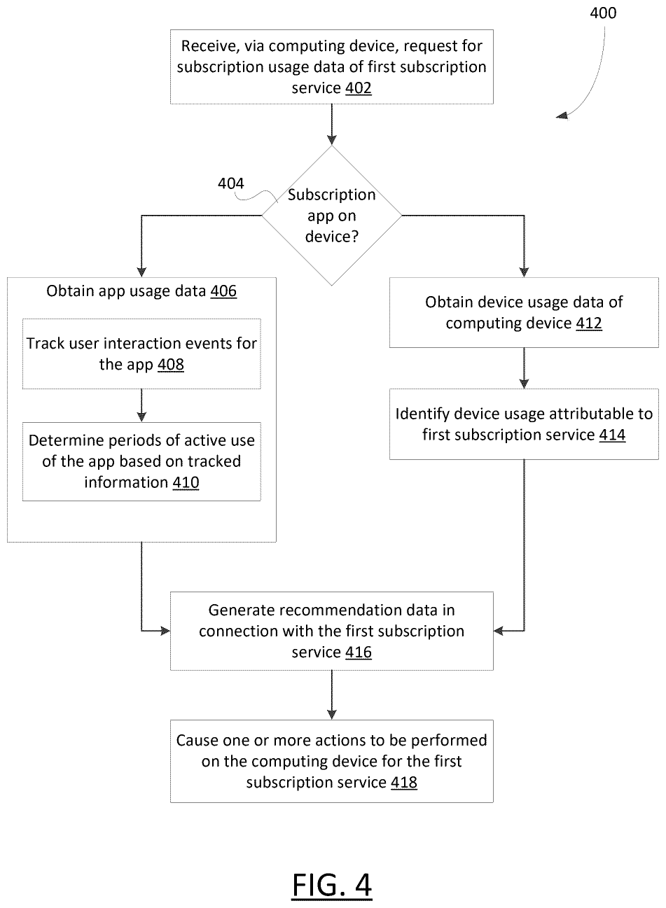

Reference is now made to FIG. 4 which shows, in flowchart form, an example method 400 for controlling access to a subscription service that is provided on a computing device. The method 400 may be implemented by a computing system that is communicably connected to one or more devices associated with a subscriber entity. A computing system that is connected to a plurality of user devices may implement the method 400 in managing access to a subscription service on each of the user devices. The operations of method 400 may be performed in addition to, or as alternatives of, one or more of the operations of method 300.

In operation 402, the computing system receives, via a computing device, a request for subscription usage data in connection with a first subscription service. For example, a user of the computing device may submit a request for information, or metrics, relating to their use of the first subscription service over a defined period of time. The computing device may be one of the devices that are associated with the first subscription service—that is, the user may access the first subscription service and its features using the computing device.

The computing system determines whether a subscription application associated with the first subscription service is installed on the computing device, in operation 404. That is, the computing system performs a check to determine if the computing device stores, in memory, a software application, such as a mobile app, enabling access of the first subscription service. The subscription application may be configured, by default, to compile various statistics relating to usage of the application. The application data of the subscription application may thus provide useful information relating to usage of the first subscription service on the computing device which may, in turn, inform the usage metrics for the first subscription service across a plurality of user devices.

If the computing device does store a subscription application for the first subscription service, the computing system obtains application usage data of the subscription application, in operation 406. The application usage data may be a subset of application data associated with the subscription application that is available to be accessed. The computing system may query the computing device to receive the application usage data. The application usage data may be determined based on tracking user interaction events for the subscription application (operation 408). In particular, the computing device and/or the computing system may be configured to track user actions for interacting with the subscription application.

In some instances, the application usage data may be supplemented by the computing device's independently tracked data regarding user interactions with the subscription application. For example, if the application usage data primarily consists of device screen time, it may not be a comprehensive or accurate measure of usage of the first subscription service. The data from the subscription application may be supplemented with tracked user interaction events data in determining actual usage of the first subscription service on the computing device. The computing system may determine periods of active use of the subscription application based on the tracked information, including application usage data (operation 410).

If, on the other hand, the computing system determines that there is no subscription application associated with the first subscription service on the computing device, the computing system obtains device usage data relating to the first subscription service, in operation 412. That is, the computing system may not rely on data supplied by a subscription application-instead, it uses independently tracked device usage information in order to infer usage of the first subscription service. The computing system identifies device usage that is attributable to the first subscription service (operation 414).

In operation 416, the computing system generates recommendation data in connection with the first subscription service. The recommendation data may be generated based on, at least, the device usage data or the application usage data. In at least some implementations, the recommendation data may comprise usage records representing periods of continuous use of the first subscription service. Each usage record may be a record that indicates continuous use of the first subscription service on any one of a subscriber's devices. The data fields of a usage record may include, among other information: date and time of use; total usage time; platform or source of usage data (e.g., mobile app, subscriber's router, etc.); and description of the service use (e.g., media item consumed, etc.).

In generating the recommendation data, the computing system may leverage the aggregated data of the usage records to determine values of certain metrics relating to usage and utility of the first subscription service. For example, the computing system may determine the device user's total usage-per-period. The period may be initially defined by the terms of a subscription agreement associated with the first subscription service (e.g., per month, year, etc.), and then normalized to the user's preferred unit of comparison. Similarly, the usage may be defined in [days]:[hours]:[minutes], and then normalized to the user's preferred unit of comparison. Additionally, or alternatively, the computing system may be configured to calculate a measure of the utility of the first subscription service. That is, the utility derived from access/use of the first subscription service may be expressed in monetary terms. To calculate the utility, the cost-per-period may be divided by the usage-per-period to obtain cost-per-usage, expressed in the user's preferred units (e.g., dollars per unit-time).

In operation 418, the computing system causes one or more actions to be performed on the computing device for the first subscription service. In particular, the actions may be caused to be performed based on the generated recommendation data. For example, the computing system may cause to be modified at least one device setting of the computing device. The changes may relate, for example, to controlling access to the first subscription service on the computing device.

In some implementations, the computing system may cause to be enabled, on the computing device, a restriction on usage of an application associated with the first subscription service. In particular, one or more application settings of the application for accessing the first subscription service may be automatically initialized or modified. For example, the computing system may impose a defined maximum/upper limit on usage-per-period of the application on the computing device. In this way, the use of the first subscription service on the computing device over any defined unit of time may be controlled to align with recommendations generated by the computing system

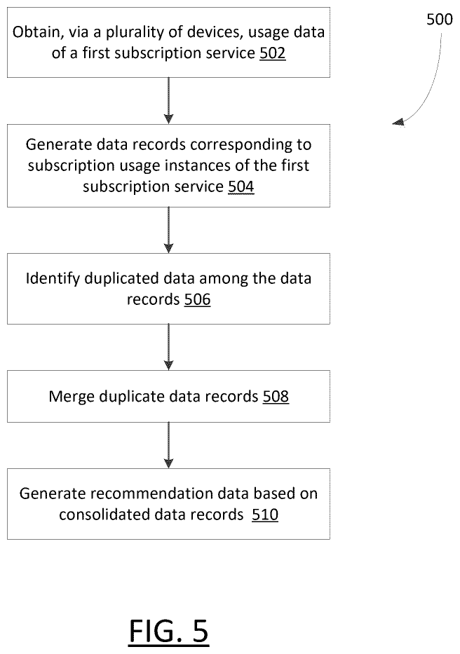

Reference is now made to FIG. 5 which shows, in flowchart form, an example method 500 for providing customized recommendations based on subscription usage data across a plurality of devices. The method 500 may be implemented by a computing system that is communicably connected to one or more devices associated with a subscriber entity. A computing system that is connected to a plurality of user devices may implement the method 500 in managing access to a subscription service on each of the user devices. The operations of method 500 may be performed in addition to, or as alternatives of, one or more of the operations of methods 300 and 400.

In operation 502, the computing system obtains, via a plurality of devices, usage data of a first subscription service. The usage data may include, for example, application usage data of a subscription application associated with the first subscription service. Additionally, or alternatively, the usage data may include device usage data tracked by a computing device that is used for accessing the first subscription service. The device usage data may be determined by the computing device, for example, based on tracking at least one of sensor data of sensors associated with the computing device or device interaction events associated with the first subscription service comprising user input for interacting with the computing device.

The computing system generates data records (“usage records”) corresponding to subscription usage instances of the first subscription service, in operation 504. The usage records represent periods of continuous use of the first subscription service. Each usage record may be a record that indicates continuous use of the first subscription service on any one of a subscriber's devices. The data fields of a usage record may include, among other information: date and time of use; total usage time; platform or source of usage data (e.g., mobile app, subscriber's router, etc.); and description of the service use (e.g., media item consumed, etc.).

In operation 506, the computing system identifies duplicated data among the usage records. In at least some implementations, the duplicated data is identified based on comparing values in data fields of the usage records. The data fields may comprise at least one of usage period, subscription name, or usage duration. By performing comparisons of the values of the data fields associated with the usage records, duplicated data (or data inferred to be duplicated) may be identified. For each data field, a threshold difference may be defined and used in order to identify duplicated data. A suitable threshold difference may be selected based on the type and content of the data field. If the difference between the data field values of any two usage records is less than the threshold difference, the usage records may be deemed to be duplicates of each other.

In operation 508, the computing system merges duplicated usage records. In particular, any two or more usage records that are determined to be duplicates of each other are caused to be merged into a single usage record. A merged usage record may contain all or a subset of the information contained in the two or more merging usage records. For example, a merged usage record may include information that summarizes, expands on, or otherwise combines the data of the merging usage records. In this way, “consolidated” usage records may be obtained, at least in part, by eliminating duplicated data from the set of all usage records. The computing system may generate recommendation data based on the consolidated usage records. The recommendation data may comprise values of certain metrics relating to usage and utility of the first subscription service.

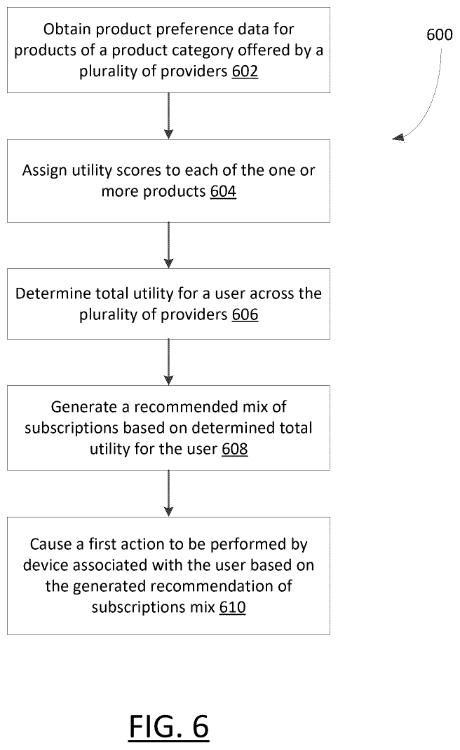

Reference is now made to FIG. 6 which shows, in flowchart form, an example method 600 for determining a recommended mix of subscriptions based on feature overlap analysis. The method 600 may be implemented by a computing system that is communicably connected to one or more devices associated with a subscriber entity. A computing system that is connected to a plurality of user devices may implement the method 600 in managing access to a subscription service on each of the user devices. The operations of method 600 may be performed in addition to, or as alternatives of, one or more of the operations of methods 300, 400 and 500.

The method 600 facilitate utility-based optimization of subscription selections. An optimal mix of subscriptions may be recommended to a user based on, at least, service-offering preferences and subjective ranking preferences. In operation 602, the computing system obtains the user's product preference data for products of a product category offered by a plurality of subscription providers. If the user desires to increase the utility of spending in a specific subscription category, the computing system may review the products available to the user from the plurality of subscription providers in the category and enable the user to identify preferences in relative and absolute terms. In at least some implementations, the computing system may receive, via one or more computing devices, user input of a preference score for each of the one or more products. The preference scores may represent absolute preferences (e.g., products which the user considers irreplaceable) and relative preferences (e.g., list of favorite products, ranked or unranked) of the user.

In operation 604, the computing system assigns utility scores to each of the one or more products. In some implementations, a default first score may be assigned to products of a first type, and second scores may be assigned to one or more products of a second type. For example, the first type may correspond to “replaceable” products, and the second type may correspond to “irreplaceable” products.

In operation 606, the computing system determines a total utility for a user across the plurality of subscription providers. That is, for each subscription provider, a total utility available to the user is determined. In some implementations, the assigned scores of the one or more products may be tuned based on user data of related users. In particular, the “default” scores may be tuned to reflect users that are “related” to the user. The “related users” may be identified based on at least one of demographic information and product preference information.

In operation 608, the computing system generates a recommended mix of subscriptions based on the determined total utility for the user. The recommended mix represents an “optimal” combination of subscriptions that allows the user to achieve greatest possible utility. In some implementations, the recommended mix may be generated by determining a filter indicating products that are not to be included among products offered to the user from the plurality of providers. The filter may, for example, be determined based on a ranking of the one or more products based on their assigned utility scores.

In operation 610, the computing system causes a first action to be performed by the computing device associated with the user based on the generated recommendation of subscriptions mix. For example, the computing system may generate a message containing an indication of the recommended mix of subscriptions. As another example, the computing system may cause the computing device(s) to enable restrictions associated with one or more on-device applications that are associated with at least a subset of the applications associated with the user's subscriptions.

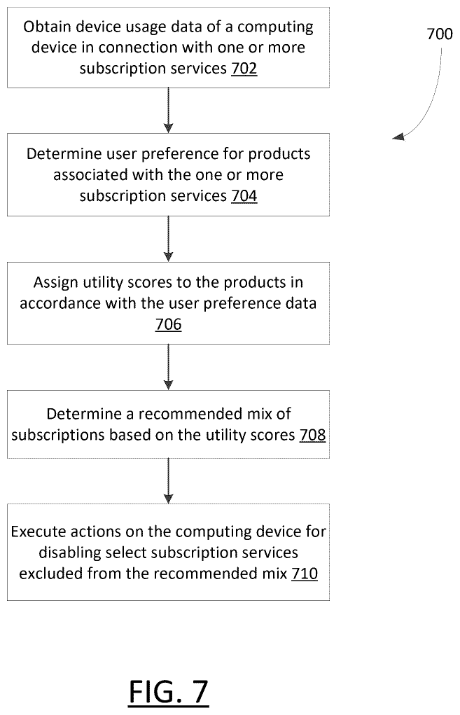

Reference is now made to FIG. 7 which shows, in flowchart form, an example method 700 for tracking device usage across a plurality of devices for determining user preference data and a recommended mix of subscriptions. The method 700 may be implemented by a computing system that is communicably connected to one or more devices associated with a subscriber entity. The operations of method 700 may be performed in addition to, or as alternatives of, one or more of the operations of methods 300, 400, 500 and 600.

In operation 702, the computing system obtains device usage data of a computing device in connection with one or more subscription services. The device usage data may comprise various information describing usage of the computing device by a user to access the one or more subscription services. As described above, the device usage data may be determined by tracking, for example, sensor data of sensors associated with the computing device and/or device interaction events associated with the subscription services comprising user input for interacting with the computing device.

In operation 704, the computing system determines user preference for products associated with the one or more subscription services. The user preference may be represented, for example, by preference scores (or other indicators) that are input by the user in connection with products that are included as part of the subscription services.

In operation 706, the computing system assigns utility scores to the products in accordance with the user preference data. In some implementations, a default utility value may be assigned to products that the user considers to be replaceable, and a unique utility score may be assigned to each product that is considered by the user to be “irreplaceable”. The computing system then determines a recommended mix of subscriptions based on the utility scores, in operation 708.

In operation 710, the computing system executes actions on the computing device for disabling select subscription services that are excluded from the recommended mix. That is, the computing system may cause the computing device to actively disable (or remove) applications associated with subscription services that are not included in the recommended mix. For example, the computing device may automatically install or prompt a user to confirm disabling/removal of applications that are used for accessing the excluded subscription services.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system, comprising:
a processor;
a memory coupled to the processor, the memory storing computer-executable instructions that, when executed by the processor, configure the processor to:
obtain, via a computing device, device usage data associated with a first service that is accessible on the computing device;
query at least one network node of a first network to obtain network resource usage data associated with the computing device;
generate recommendation data comprising a plurality of data records corresponding to usage instances for the first service based on the device usage data and the network resource usage data; and
cause to be modified at least one device setting of the computing device based on the generated recommendation data.

2. The computing system of claim 1, wherein the device usage data associated with the first service is obtained based on tracking at least one of:
sensor data of sensors associated with the computing device, the sensor data corresponding to defined device actions associated with the first service; or
device interaction events associated with the first service comprising input for interacting with the computing device.

3. The computing system of claim 2, wherein the memory stores a first application associated with the first service and wherein obtaining the device usage data comprises tracking sensor data of the sensors during periods of usage of the first application.

4. The computing system of claim 1, wherein generating the recommendation data comprises identifying duplicated data among the plurality of data records for merging into a single data record.

5. The computing system of claim 4, wherein the duplicated data is identified based on comparing values in data fields comprising at least one of usage period, subscription name, or usage duration associated with the data records.

6. The computing system of claim 3, wherein obtaining the device usage data comprises querying the computing device for device screen time associated with periods of usage of the first application.

7. The computing system of claim 1, wherein the instructions, when executed, further configure the processor to obtain output of custom software for collecting at least one of connection usage time or browser application usage time.

8. The computing system of claim 1, wherein causing the at least one device setting to be modified comprises enabling a restriction on usage of a first application.

9. The computing system of claim 1, wherein the instructions, when executed, further configure the processor to obtain tracking data of a health tracking service for a user of computing device, wherein the recommendation data includes recommended subscriptions usage information based on the tracking data and usage patterns associated with the first subscription service.

10. The computing system of claim 1, wherein the at least one network node comprises a computer server associated with a connection service provider (CSP).

11. A computer-implemented method, comprising:
obtaining, via a computing device, device usage data associated with a first service that is accessible on the computing device;
querying at least one network node of a first network to obtain network resource usage data associated with the computing device;
generating recommendation data comprising a plurality of data records corresponding to usage instances for the first service based on the device usage data and the network resource usage data; and
causing to be modified at least one device setting of the computing device based on the generated recommendation data.

12. The method of claim 11, wherein the device usage data associated with the first service is obtained based on tracking at least one of:
sensor data of sensors associated with the computing device, the sensor data corresponding to defined device actions associated with the first service; or
device interaction events associated with the first service comprising input for interacting with the computing device.

13. The method of claim 12, wherein the computing device stores, in a memory, a first application associated with the first service and wherein obtaining the device usage data comprises tracking sensor data of the sensors during periods of usage of the first application.

14. The method of claim 11, wherein generating the recommendation data comprises identifying duplicated data among the plurality of data records for merging into a single data record.

15. The method of claim 14, wherein the duplicated data is identified based on comparing values in data fields comprising at least one of usage period, subscription name, or usage duration associated with the data records.

16. The method of claim 13, wherein obtaining the device usage data comprises querying the computing device for device screen time associated with periods of usage of the first application.

17. The method of claim 11, further comprising obtaining output of custom software for collecting at least one of connection usage time or browser application usage time.

18. The method of claim 11, further comprising causing a message containing the generated recommendation data to be presented via the computing device.

19. The method of claim 11, further comprising obtaining tracking data of a health tracking service for a user of computing device, wherein the recommendation data includes recommended subscriptions usage information based on the tracking data and usage patterns associated with the first subscription service.

20. (canceled)

21. The computing system of claim 1, wherein the recommendation data is generated by a recommendation engine that is implemented as an artificial intelligence (AI)-powered assistant.
